(19) United States
(12) Patent Application Publication
(10) Pub. No.: US 2022/0314673 A1
(43) Pub. Date: Oct. 6, 2022

(54) Printing Plate and Polymeric Coating Material for the Same

(71) Applicants: Leibniz-Institut für Oberflächenmodifizierung e.V., Leipzig (DE); Maschinenfabrik Kaspar Walter GmbH & Co. KG, Krailing (DE)

(72) Inventors: Ulrike Helmstedt, Leipzig (DE); Annette Freyer, Leipzig (DE); Helmut Herrnberger, Leipzig (DE); Oliver Fechner, Krailling (DE); Christoph Gschossmann, Krailling (DE)

(21) Appl. No.: 17/641,956

(22) PCT Filed: Jun. 19, 2020
(86) PCT No.: PCT/EP2020/067145

§ 371 Date: Mar. 10, 2022

(30) Foreign Application Priority Data
Sep. 16, 2019 (DE) 10 2019 124 814.0

(51) Int. Cl. B41M 1/10; B41C 1/05; C08K 3/22; C09D 7/40; C09D 7/61; C08K 3/36; C08K 5/56

(52) U.S. Cl. CPC B41M 1/10; B41C 1/05; C08K 3/22; C09D 7/68; C09D 7/61; C08K 3/36; C08K 5/56; B41C 2201/02; B41C 2201/14; C08K 2201/005; C08K 2201/011; C08K 2201/001; C08K 2003/2227; C08K 2003/2241; C08K 2003/2231; C08K 3/2279; C08K 2003/2244

(57) ABSTRACT

The invention relates to a coating material for coating a metal or non-metal printing plate, comprising a liquid starting material which can be polymerised using UV light in order to form a polymer matrix, and comprising a filling material which can be covalently incorporated into a polymer matrix of the starting material. The filling material is of a sub-microscale size, wherein absorption of IR radiation can be brought about by the filling material in the starting material, said absorption being higher than an absorption without filling material. The invention also relates to a printing plate comprising a cylindrical main body, wherein a polymer layer is applied to at least parts of a circumferential surface of the main body, with the polymerisation thereof being induced by UV light, wherein the polymer layer has a sub-microscale filling material, and wherein a higher absorption of infrared radiation is brought about using the filling material in the polymer layer than in the polymer layer without filling material.

### TECHNICAL FIELD

The invention relates to a printing plate and a polymeric coating material for same. In particular, the invention relates to a polymeric nanocomposite as a single layer for printing plates, in particular, for gravure plates or cylinders, patterning plates or cylinders, embossing plates or cylinders, as well as letterpress plates or cylinders or coating rollers, as well as inking rollers, e.g., for flexographic printing, with tribological properties sufficient for the requirements of modern printing.

### BACKGROUND

In the following text, the term “printing plate” will, in particular, be used as a generic term for gravure plates, letterpress plates or patterning plates for embossing, but also for coating rollers or inking rollers. In particular, gravure plates or letterpress plates are used for printing a wide variety of objects, such as magazines and packaging, while patterning plates are used for embossing a relief-like pattern into a usually soft surface.

In the case of gravure printing, gravure cylinders with a metallic base body coated on the circumference with a galvanic coating have become particularly popular. The imaging layer is made of copper, to which a hard chrome layer is applied as wear protection. An engraving is then made in the galvanic copper surface with the aid of a mechanical graver or a laser, which represents the actual printing plate. It has proven useful to make the engraving in the form of small depressions, so-called cells, which absorb the printing ink in the subsequent printing process and transfer it to the object to be printed, for example, a paper or plastic web.

The production of suitable coatings on printing plates, in particular, gravure or patterning cylinders, using the galvanic process is costly and requires several manufacturing steps.

In order to avoid costly metallic galvanizations, coating the metallic base body of a gravure cylinder with a polymer layer that is curable by UV light has already been considered. UV-curable polymer layers are usually transparent due to the penetrating UV radiation required for curing. If the transparency is reduced by adding additives, the penetration depth or energy density of the penetrating UV radiation is also reduced. As a result, there is a risk that with greater layer thicknesses or lower transparency, polymerization no longer takes place completely and complete curing of the polymer layer cannot be achieved.

The patterning of transparent polymer layers, in particular, the introduction of a surface pattern, for example, in the form of cells or patterns for ink absorption or embossing, can generally only be achieved with the aid of UV lasers. However, UV lasers are expensive to purchase, slow to operate and costly to maintain. Due to the requirements in gravure printing with regard to rapid patterning of the surface, i.e., rapid introduction of the printing plate into the surface, UV lasers are only suitable to a limited extent.

The use of faster, industrially available and cost-efficient infrared lasers (IR lasers) with a sufficient quality of ablation is usually not possible on transparent (polymer) layers, since the infrared light is not absorbed by the transparent layer and therefore penetrates through the polymer layer to the (for example, metallic) base body and only causes ablation there. Ablation and thus patterning on the surface of the transparent polymer layer to produce gravure cells cannot be achieved as a result.

As an alternative to UV curing of a polymer layer on a gravure cylinder, thermal curing is also conceivable, but is not effective because of the long tempering times. It should be noted that gravure cylinders are usually made of solid steel or aluminum bodies and are usually designed as thick-walled tubes with or without welded-on axles. Heating up such massive bodies requires a corresponding amount of times.

The cells commonly used in gravure printing have, for example, a maximum depth of 40 μm. Thus, taking into account concentricity errors of the cylinders, allowances during machining and avoidance of stray light, a minimum layer thickness of a polymer layer of 100 μm will be attained. If we assume the current practice of grading within a set of cylinders, a maximum layer thickness of 250 to 300 μm will at most have to be achieved. Grading is understood to mean a graduation in diameter within a set of cylinders for a printing machine with, e.g., 6 cylinders, with the difference in diameter from the first print cylinder to the following printing cylinder usually being 0.02 mm. This is to compensate for elongation or shrinkage of the printed web in unregulated printing machines, in order to print the printed images in perfect register on the substrate.

Thus, the problem is that although UV-curable polymer layers exist, they are transparent and thus can only be imaged with sufficient quality using a UV laser. Polymer layers that can be patterned by faster infrared lasers, on the other hand, are no longer UV-curable due to insufficient transparency (at least not over the entire layer thickness) and therefore require thermal curing, which, in turn, is very time and energy consuming.

### SUMMARY

The invention is based on the object of enabling a simple polymer coating of printing plates that enables reliable production of the layer and rapid generation of the surface pattern (gravure printing/letterpress printing or embossing plate) in connection with sufficient service life and a high printing or embossing quality.

The object, in accordance with the invention, is achieved by a printing plate with a polymer coating, as well as by a corresponding coating material for coating a metallic or non-metallic printing plate, such as a metallic or non-metallic cylinder.

A coating material for coating a printing plate is described, comprising a liquid starting material which can be polymerized by UV light in order to form a polymer matrix, and a filler that can be covalently bonded into the polymer matrix of the starting material, wherein the filler is of a sub-microscale size, and wherein the filler is capable of causing absorption of infrared radiation in the starting material which is measurably higher than absorption without a filler.

The coating material thus relates to the material that is to be applied to the cylinder, in particular, a print cylinder, on the outer circumference and is to form the desired polymer layer there. Accordingly, the coating material specified herein is still in its initial liquid state. Only by irradiation with UV light is polymerization induced and the starting material cured. Subsequently, the outer surface of the polymer layer can be patterned or marked or coded with the aid of infrared radiation, in particular, by an IR laser or NIR laser (near infrared).

Accordingly, the starting material is polymerized by UV light and subsequently patterned by IR radiation. In this process, the IR absorption is increased by adding the filler, which makes the actual laser ablation (patterning of the surface) possible. Due to its sub-microscale size, the filler is present in particle or pigment form and increases the absorption of the IR radiation.

In particular, NIR radiation with a wavelength of 780 to 3000 nm, especially up to 1064 nm, has proven suitable as IR radiation.

The starting material can, for example, be UV-curing prepolymer or monomer mixtures based on acrylates of radical UV-curing systems. In this case, the composite layer comprises a plurality of multifunctional monomers, oligomers and/or polymers that can be crosslinked by UV radiation curing. In addition, a bonding agent can be used.

The sub-microscale filler can consist of a metal oxide and/or a semi-metal oxide. Suitable metal oxides are, for example, metal oxide coated mica. Metal oxides are usually titanium dioxide, i.e., TiO2, or (Sn, Sb)O2.

The sub-microscale filler can be in pigment or particle form, with a size ranging from 100 nm to 999 nm. This particle size is suitable for absorbing IR radiation or NIR radiation.

In addition to the sub-microscale filler, the coating material can include additional fillers, in particular, nanoscale fillers, which can be nanoscale metal or semi-metal oxides in powder form or organometallic particles. Al2O3, SiO2, TiO2, ZrO2 or organometallic particles have proved to be particularly advantageous. These particles serve to increase the wear resistance of the coating.

The sub-microscale filler and the nanoscale filler can ensure transmission of UV radiation such that the starting material can be fully polymerized. The filler particles thus allow transmission of UV radiation to the extent required for UV-initiated polymerization. As a result, complete full curing or full polymerization of the starting material can be achieved in order to obtain a firmly adhesive polymer layer on the object to be coated.

In particular, the coating material can be electrically conductive and/or non-electrostatically chargeable. Thus, it has been surprisingly found that the material does not become electrostatically charged and is even discharging. This aspect is advantageous because solvent-based printing inks are frequently used in printing processes, the processing of which requires a certain level of explosion protection. It is therefore advantageous if discharge or even ignition processes can be avoided. It is possible in principle to make polymers electrically conductive by adding carbon black. However, this measure would impair the transmission of UV radiation and jeopardize the full curing of the polymer layer. By adding the fillers provided according to the invention, the addition of carbon black is unnecessary.

The coating material or the polymer layer that can be produced from the coating material by UV irradiation can be resistant to the mechanical (abrasion) stress inherent in a printing process under the influence of highly abrasive and solvent-containing printing inks or coating agents. With the aid of the coating material, it is thus possible to produce a polymer layer that is permanently resistant to a printing process and meets the tribological requirements during printing.

A printing plate is specified, comprising a base body, wherein a polymer layer, the polymerization of which is induced by UV light, is applied at least partially to a surface of the base body, wherein the polymer layer includes a sub-microscale filler, and wherein the filler in the polymer layer causes higher absorption of infrared radiation than in the polymer layer without a filler.

The term “printing plate” is understood in this context as a generic term for a large number of different applications and embodiments. In particular, the term “printing plate” is to be understood as gravure plates (e.g., gravure cylinders), letterpress plates (e.g., letterpress cylinders) or patterning plates (e.g., patterning or embossing cylinders) for embossing, as well as for coating rollers or inking rollers that, e.g., can be used in flexographic printing. Gravure plates or letterpress plates can be used for printing a wide variety of objects, such as magazines and packaging, while patterning plates serve to emboss a relief-like pattern into a usually soft surface. The printing plate can be designed cylindrical or planar.

The base body that essentially determines the printing plate can accordingly be designed cylindrical or planar. In the case of a cylindrical base body, the surface carrying the polymer layer can accordingly be a circumferential surface of the base body.

In this process, the base body is generally made of metal, such as steel or aluminum. However, the base body can also be made of plastic, glass fiber composite, carbon fiber composite or elastomer.

The printing plate or print cylinder is coated with the coating material specified above, which is subsequently irradiated with UV light to effect polymerization. Accordingly, the above specified coating material represents an initial state, and the polymer layer on the printing plate represents a final state. This polymer layer is also called nanocomposite in the context of this application.

The polymer layer can be mechanically finished after its application to the base body and after polymerization, for example, by grinding, polishing, turning, milling or turn-milling. In this way, dimensional accuracy and—e.g., in the case of a print cylinder-roundness can be improved with the polymer layer applied on the outside.

On the surface of the polymer layer, a cell, relief or letterpress pattern can be produced by means of NIR (near infrared) radiation. In particular, patterns in the form of depressions, so-called cells, can be produced on the surface of the polymer layer with the aid of an NIR laser. Ink, e.g., is subsequently introduced into these cells during the actual gravure process and is then transferred to the substrate to be printed.

The polymer layer can be opaque before irradiation with NIR radiation, whereby a color change can be effected in the polymer layer by irradiation with NIR radiation. This color change can, for example, mean a change from “opaque light” to “opaque dark” or vice versa. Other color changes are also possible.

This, e.g., is also helpful for the above-mentioned identification (e.g., marking or also coding), because the dark marking can be easily recognized. Other color changes are also possible depending on the materials used.

The color change in the polymer layer can already be caused by NIR radiation that has a lower intensity than the NIR radiation required to produce the cell pattern. Thus, although no mechanical ablation or laser ablation can be effected with lower intensity NIR radiation, the color change can already be effected. This can be used, for example, to introduce a mark or code into the polymer layer in order to mark or code the entire printing plate or the entire print cylinder in this way.

The marking or coding applied with the aid of low-intensity NIR radiation can contain data that can be read by machine. This enables automatic processing of the finished printing plate.

In addition to doping with the sub-microscale filler, the polymer layer can have doping with a nanoscale filler. This can improve the abrasion resistance of the polymer layer, so that a longer service life or longer operating hours of the print cylinder can be achieved during the printing operation.

The additional nanoscale filler is particularly suitable for improving abrasion resistance. These can be metal and/or semi-metal oxides, such as Al2O3, SiO2, TiO2, ZrO2, or organometallic particles.

A method of manufacturing a printing plate with the coating material described above includes the steps of:
applying the coating material to a surface of a base body of the printing plate;
forming a polymer layer by curing the coating material due to polymerization caused by UV radiation;
irradiating the polymer layer with NIR radiation to produce a surface pattern in the polymer layer.

Before the polymer layer is irradiated, the surface of the cured polymer layer can be machined by a suitable manufacturing process (e.g., turning, grinding, milling, turn-milling) as a further process step in order to achieve the required surface quality. This process step is optional and may be omitted if the coating quality is sufficient for the subsequent printing process.

Some aspects of the invention and the various embodiments are summarized below.

As explained above, a sub-microscale filler made of metal or semi-metal oxides is added to a polymer in accordance with the invention. The filler increases the absorption of NIR radiation for laser micropatterning. At the same time, however, the transmission of UV radiation is allowed to the extent required for UV-initiated polymerization.

Due to the NIR additive used (the sub-microscale filler), a color change occurs when a certain NIR radiation density is entered. In addition, the NIR laser machinability is increased since the additive absorbs the NIR radiation better.

The lasered cells created in the surface by ablation show up clearly on the surface of the polymer layer due to the color change.

In addition, a color change can also be achieved with a lower NIR laser output without ablation taking place on the surface.

The coating material or the polymer layer resulting therefrom is thus also curable for thicker layers with UV rays. At the same time, however, the polymer layer is so opaque due to the sub-microscale filler that processing by an NIR laser (for example, a pulsed laser source) is possible without the radiation passing through the polymer material. Rather, the NIR radiation couples to the surface of the polymer layer and allows ablation. In this process, a pulsed NIR ultrashort pulse (USP) laser, in particular, can be used.

The color change on the gravure cylinder takes place on the imaged surface in connection with the material removal that has taken place. Likewise, at lower laser output, a color change can take place without material removal.

As a result, the lasered typeface can be made clearly visible on the surface of the material, which can be used advantageously for identification or also for the insertion of (machine) data. For example, the non-destructive color change can be used for marking by means of a QR code for a print cylinder recognition system or for storing required data such as the batch number of the polymer (starting material), date of manufacture, diameter, roughness, UV curing process, order number (service house), brand identification.

Markings of this type can also be used as a zero point for register-accurate phasing of the gravure cylinders in the printing unit, as well as for transferring the data by means of a scanner directly to the pressing machine and thus pre-setting the machine, or as mere identification of the print cylinder by eye. The latter was previously only possible with optical auxiliary devices such as microscopes.

In particular, also due to the additional nanoscale filler, the material is sufficiently wear-resistant for the system with scraper, ink, substrate prevailing, e.g., in gravure printing. It is particularly worth mentioning that in gravure printing a very homogeneous, non-printing surface is required which is wear-resistant to scraper, substrate and ink and thus, in combination, represents a suitable tribological system.

These and other advantages and features are explained below by means of an example with the aid of FIG. 1.

### BRIEF DESCRIPTION OF THE DRAWINGS

FIG. 1 schematically shows a section through a print cylinder serving as a printing plate with a polymer layer according to the invention.

### DETAILED DESCRIPTION

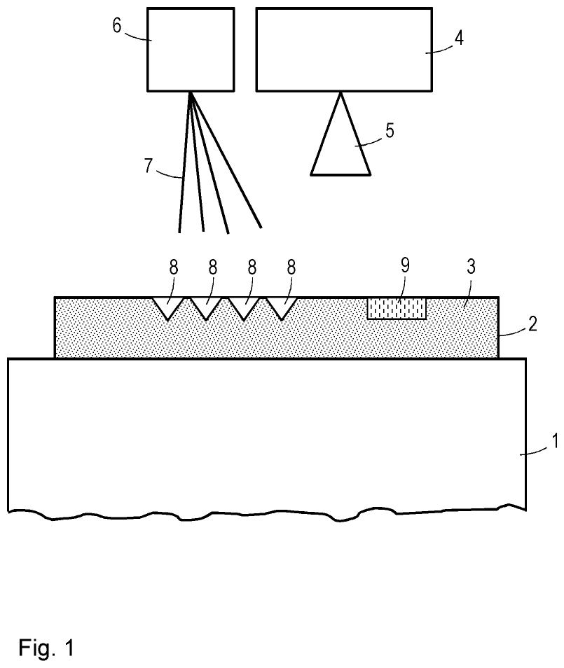

FIG. 1 shows a cylindrical base body 1, which can consist of metal, non-metal or plastic. This base body 1 is the actual print cylinder serving as a printing plate, which can be installed in a printing machine, e.g., as a gravure cylinder. Based on the example of FIG. 1, the invention is to be explained with reference to the gravure process. Similarly, the invention can also be applied to a letterpress process or to a patterning or embossing plate. The base body can also consist of plastic, glass fiber composite, carbon fiber composite or elastomer or a combination thereof.

A polymer layer 2 is formed on the cylindrical circumferential surface of the base body 1, based on a nanocomposite in which various fillers are incorporated into the polymer layer 2. The polymer layer 2 essentially consists of an acrylate or acrylate mixture curable with UV light. In addition, fillers 3 are introduced into the polymer layer 2. The fillers 3, in particular, are sub-microscale fillers whose particles or pigments are in a size range between 100 nm and 999 nm. These fillers serve to improve the absorption of infrared radiation and thus to improve laser ablation, as already explained above in the general section.

In addition, FIG. 1 shows a UV light source 4 with which UV radiation 5 can be generated. The UV radiation 5, in particular, serves to polymerize the flowable starting material underlying the polymer layer 2, i.e., in particular, the acrylate or the acrylate mixture, and thus to produce and cure the polymer layer 2.

Furthermore, FIG. 1 shows an NIR laser 6 (infrared laser) with which NIR radiation 7 can be produced. The NIR laser 6 can be a USP (ultrashort pulse) laser.

With the aid of the infrared radiation 7 impinging on the polymer layer 2, cells 8 in the form of depressions can be created in the surface of the polymer layer 2, which are supposed to receive the actual printing ink in the subsequent gravure process.

The cells 8 can have different shapes and cross sections. For example, the inlet cross section of a cell can, e.g., be square, rectangular, diamond-shaped, triangular or circular. Other shapes are also possible. From this inlet cross section, the cell 8 extends into the depth or into the material, with different shapes being possible here as well.

In letterpress printing, the printing ink is accordingly not introduced into the cells 8 in the usual manner, but is applied to printing dots or surfaces left standing. During embossing, a relief is formed in the surface, which is then pressed into a carrier material.

The UV light source 4 and the NIR laser 6 are shown side by side in FIG. 1. However, they can be arranged in different apparatus or processing stations for logical reasons. In particular, a processing station can be provided for producing the polymer layer 2 on the base body 1. Subsequently, the print cylinder thus manufactured can be mechanically finished in an additional station, not shown, in order to smooth the surface of the polymer layer 2 and improve the roundness. Here, for example, a grinding process, turning, polishing, milling or turn-milling is suitable.

Only subsequently, in a “patterning” process step, the print cylinder can then be introduced into a station in which the NIR laser 6 is present in order to generate the cells 8 and thus the printing pattern (printing plate) in the surface of the polymer layer 2.

In addition, a marking field 9 is shown in the surface of the polymer layer 2. As explained above, it is possible to use lower-intensity infrared radiation to cause only a color change in the polymer layer 2 without laser ablation, i.e., a patterning of the surface. This makes it possible, for example, to produce the marking field 9, in which information such as a QR code or other codings can be stored.

Only when irradiated with higher-intensity infrared radiation 7, the actual cells 8 can be produced by laser ablation.

Various examples are given below for the production of the nanocomposite.

### Example 1

56 g Ebecryl 837, 14 g Sartomer SR 494, 1.75 g DYNASYLAN VTMO and a solution of 64 mg maleic acid in 0.64 g water are stirred in a 250 ml stirred vessel. Then, with continuous stirring, 5-40 m % Almal's nanopowder is added within 120 minutes and stirred for another 3 hours. After addition of 2.6 g DYNASYLAN VTMO and 5.2 g Iriotec 8210, the mixture must be stirred for another three hours.

### Example 2

23 g Ebecryl 1290, 46.4 g Sartomer SR 494, 12.5 g DYNASYLAN VTMO and a solution of 460 mg maleic acid in 4.6 g water are stirred in a 250 ml stirred vessel. Then, with continuous stirring, 5-40 m % Almal's nanopowder is added within 120 minutes and stirred for another 4 hours. After addition of 2.8 g DYNASYLAN VTMO and 5.6 g Iriotec 8210, the mixture must be stirred for another three hours.

### Example 3

56 g Ebecryl 837, 14 g Sartomer SR 494, 1.35 g DYNASYLAN VTMO and a solution of 48 mg maleic acid in 0.48 g water are stirred in a 250 ml stirred vessel. Then, with continuous stirring, 5-20 m % ZrO2 nanopowder is added within 120 minutes. Stirring continues for another 3 hours and then 3.0 g of Sartomer SR 297 is added to the mixture. After addition of 2.6 g DYNASYLAN VTMO and 5.2 g Iriotec 8210, the mixture must be stirred for another three hours.

1-15. (canceled)

16. A coating material for coating a printing plate, the coating material comprising:
a liquid starting material configured to be polymerized by UV light to form a polymer matrix; and
a sub-microscale filler which is of a sub-microscale size,
wherein the coating material, in addition to the sub-microscale filler, contains an additional filler,
wherein the sub-microscale filler is in particle form and the sub-microscale size is in a range between 100 nm and 999 nm,
wherein the additional filler is a nanoscale filler, such that the additional filler includes filler particles with a nanoscale size in a range between 1 nm and 99 nm,
wherein the sub-microscale filler comprises at least one metal oxide and/or one semi-metal oxide selected from the group consisting of metal oxide coated mica, TiO₂ and (Sn, Sb)O₂,
wherein the nanoscale filler is a metal oxide and/or a semi-metal oxide selected from the group consisting of Al₂O₃, SiO₂, TiO₂, ZrO₂ and organometallic particles,
wherein the sub-microscale filler is configured to be covalently bonded into the polymer matrix of the liquid starting material,
wherein the nanoscale filler is included to increase wear resistance, and is covalently bonded into the polymer matrix of the liquid starting material,
wherein the sub-microscale filler is configured to cause absorption of IR radiation in the liquid starting material which is higher than absorption without a filler.

17. The coating material of claim 16, wherein the liquid starting material comprises an acrylate curable by UV light.

18. The coating material of claim 16, wherein the sub-microscale filler and the nanoscale filler ensure transmission of UV radiation, such that the liquid starting material can be fully polymerized.

19. The coating material of claim 16, wherein the coating material is electrically conductive and/or not electrostatically chargeable.

20. A printing plate, comprising:
a base body; and
a polymer matrix including a polymer layer, polymerization of which is induced by UV light, and applied at least partially to a surface of the base body,
wherein the polymer layer includes a sub-microscale filler,
wherein the polymer layer, in addition to the sub-microscale filler, includes an additional filler,
wherein the sub-microscale filler is in particle form with a size in a range between 100 nm and 999 nm,
wherein the additional filler is a nanoscale filler, which includes filler particles with a nanoscale size in a range between 1 nm and 99 nm,
wherein the sub-microscale filler comprises at least one metal oxide and/or one semi-metal oxide selected from the group consisting of metal oxide coated mica, TiO₂ and (Sn, Sb)O₂,
wherein the nanoscale filler is a metal oxide and/or a semi-metal oxide selected from the group consisting of Al₂O₃, SiO₂, TiO₂, ZrO₂ and organometallic particles,
wherein the sub-microscale filler is covalently bonded into the polymer matrix,
wherein the nanoscale filler is included to increase wear resistance, and is covalently bonded into the polymer matrix,
wherein the sub-microscale filler in the polymer layer causes higher absorption of infrared radiation than in the polymer layer without a filler.

21. The printing plate of claim 20, wherein the polymer layer is mechanically finished after application to the base body and after polymerization.

22. The printing plate of claim 20, wherein a surface of the polymer layer is configured to be patterned with a cell pattern or a relief pattern produced by NIR radiation.

23. The printing plate of claim 20, wherein the polymer layer is opaque prior to irradiation with NIR radiation, and wherein a color change can be effected in the polymer layer by irradiation with NIR radiation.

24. The printing plate of claim 23, wherein the color change for introducing markings or codings into the polymer layer is already effected by NIR radiation with a lower intensity than the NIR radiation required for producing the cell pattern.

25. The printing plate of claim 24, wherein the marking or coding contains data that is readable by machine.

26. A method of manufacturing a printing plate with a coating material that comprises a liquid starting material configured to be polymerized by UV light to form a polymer matrix and a sub-microscale filler which is of a sub-microscale size, wherein the coating material, in addition to the sub-microscale filler, contains an additional filler, wherein the sub-microscale filler is in particle form and the sub-microscale size is in a range between 100 nm and 999 nm, wherein the additional filler is a nanoscale filler, such that the additional filler includes filler particles with a nanoscale size in a range between 1 nm and 99 nm, wherein the sub-microscale filler comprises at least one metal oxide and/or one semi-metal oxide selected from the group consisting of metal oxide coated mica, TiO2 and (Sn, Sb)O2, wherein the nanoscale filler is a metal oxide and/or a semi-metal oxide selected from the group consisting of Al2O3, SiO2, TiO2, ZrO2 and organometallic particles, wherein the sub-microscale filler is configured to be covalently bonded into the polymer matrix of the liquid starting material, wherein the nanoscale filler is included to increase wear resistance, and is covalently bonded into the polymer matrix of the liquid starting material, wherein the sub-microscale filler is configured to cause absorption of IR radiation in the liquid starting material which is higher than absorption without a filler, the method comprising:
applying the coating material to a surface of a base body of the printing plate;
forming a polymer layer by curing the coating material due to polymerization caused by UV radiation; and
irradiating the polymer layer with NIR radiation to produce a surface pattern in the polymer layer.
